(19) United States
(12) Patent Application Publication
(10) Pub. No.: US 2017/0226794 A1
(43) Pub. Date: Aug. 10, 2017

(54) DRIVING DEVICE FOR WINDOW BLIND

(71) Applicant: TAICANG KINGFU PLASTIC MANUFACTURE CO., LTD., Taicang (CN)

(72) Inventor: Szu-Chang Huang, Fusing Township (TW)

(21) Appl. No.: 15/418,425

(22) Filed: Jan. 27, 2017

(30) Foreign Application Priority Data
Feb. 5, 2016 (CN) 201620116475.1

(51) Int. Cl. E06B 9/322; E06B 9/326

(52) U.S. Cl. CPC E06B 9/322; E06B 9/326

(57) ABSTRACT

A driving device for a window blind includes a rotary unit and a driving unit . The rotary unit includes a rotary shaft and a screw nut. The rotary shaft is mounted in a receiving space of a lower rail, is rotatable relative to the lower rail about an extending axis thereof, and is configured to permit pull cords to be wound thereon, such that rotation of the rotary shaft drives the lower rail to move relative to an upper rail. The screw nut engages a threaded section of the rotary shaft and is fixedly connected to the lower rail, such that the rotary shaft moves along the extending axis relative to the lower rail upon the rotation thereof relative to the lower rail. The driving unit is linked to the rotary shaft for driving the rotation of the rotary shaft.

### CROSS-REFERENCE TO RELATED APPLICATION

This application claims priority of Chinese Patent Application No. 201620116475.1, filed on February 5, 2016.

### FIELD

The disclosure relates to a driving device, more particularly to a driving device for a window blind.

### BACKGROUND

Conventional window blinds may include a frame unit, and a blind unit that is mounted to the frame unit and that is controlled by an operation cord. However, such an operation cord may cause safety concerns especially when the conventional window blinds are disposed at places where the operation cord can be reached by children.

### SUMMARY

Therefore, an object of the disclosure is to provide a driving device that may alleviate the drawback of the prior art.

According to the present disclosure, a driving device for a window blind may be provided. The window blind includes an upper rail, a lower rail defining a receiving space and having an opening, a plurality of slat members disposed between the upper and lower rails, and two pull cords each being connected to the upper rail and extending through the slat members and into the receiving space via the opening. The driving device includes a rotary unit and a driving unit . The rotary unit includes a rotary shaft, and a screw nut. The rotary shaft is mounted in the receiving space of the lower rail, is rotatable relative to the lower rail about an extending axis thereof, and is configured to permit the pull cords to be wound thereon, such that rotation of the rotary shaft drives movement of the lower rail relative to the upper rail. The rotary shaft has a threaded section. The screw nut threadedly engages the threaded section of the rotary shaft and is fixedly connected to the lower rail, such that the rotary shaft moves along the extending axis relative to the lower rail upon the rotation thereof relative to the lower rail . The driving unit is linked to the rotary shaft for driving the rotation of the rotary shaft.

### BRIEF DESCRIPTION OF THE DRAWINGS

Other features and advantages of the disclosure will become apparent in the following detailed description of the embodiment with reference to the accompanying drawings, of which:

FIG. 1 is a front schematic view of a first exemplary embodiment, illustrating a driving device of a window blind according to the present disclosure;

FIG. 2 is another front view of the exemplary embodiment;

FIG. 3 is a fragmentary sectional view of the exemplary embodiment;

FIG. 4 is another fragmentary sectional view of the exemplary embodiment;

FIG. 5 is a partly sectional view of the exemplary embodiment, illustrating a holding member of the driving device;

FIG. 6 is a front view of a second exemplary embodiment according to the present disclosure; and

FIG. 7 is a partly sectional view of the second exemplary embodiment, illustrating a driving unit of the driving device.

### DETAILED DESCRIPTION

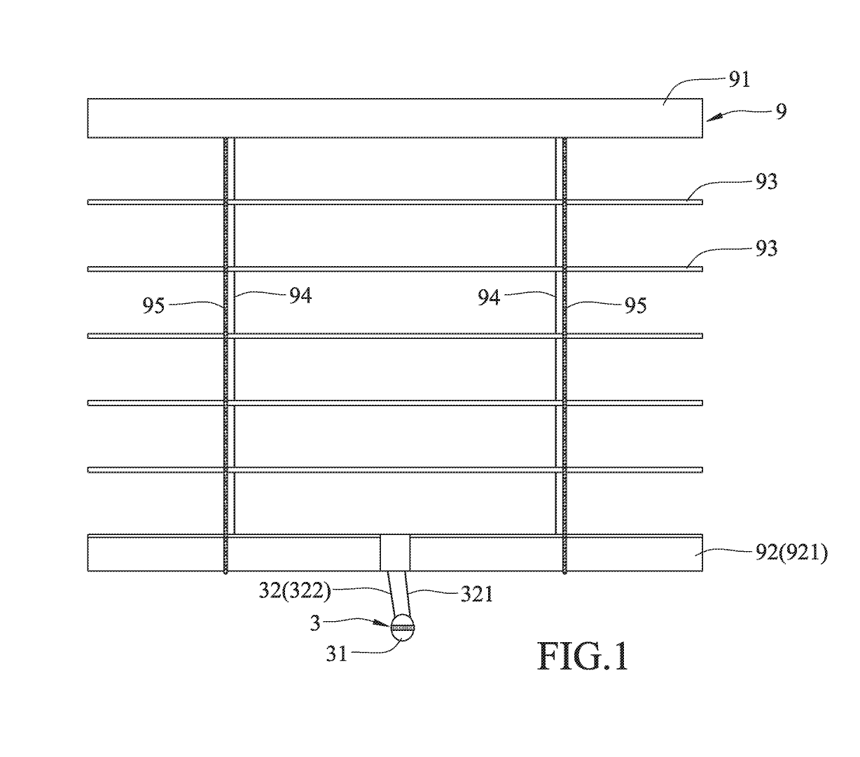

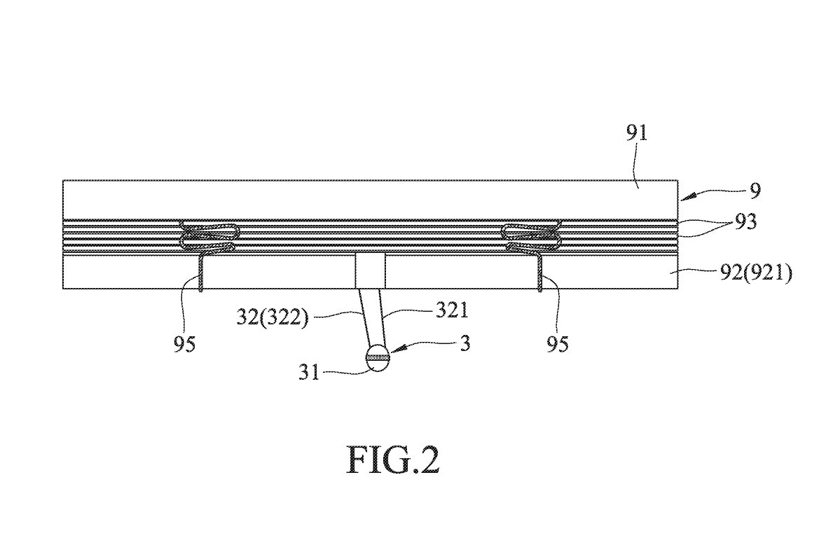

Referring to FIGS. 1 to 4, a first exemplary embodiment of a driving device is adapted for a window blind 9 including an upper rail 91, a lower rail 92, a plurality of slat members 93, two pull cords 94, and two slat-rotating cords 95. The lower rail 92 has a casing 921 defining a receiving space 923, and an opening 922 in spatial communication with the receiving space 923. The slat members 92 are disposed between the upper and lower rails 91, 92. Each of the pull cords 94 is connected to the upper rail 91 and extends through the slat members 93 and into the receiving space 923 via the opening 922. The slat-rotating cords 95 are disposed between the upper and lower rails 91, 92 to support the slat members 93, and are operable to drive rotation of each of the slat members 93 in two opposite rotational directions, respectively. Since the operation of the slat-rotating cords 95 is well known in the art, it is omitted herein for the sake of brevity.

The first exemplary embodiment of the driving device according to the present disclosure includes a rotary unit 2 and a driving unit 3.

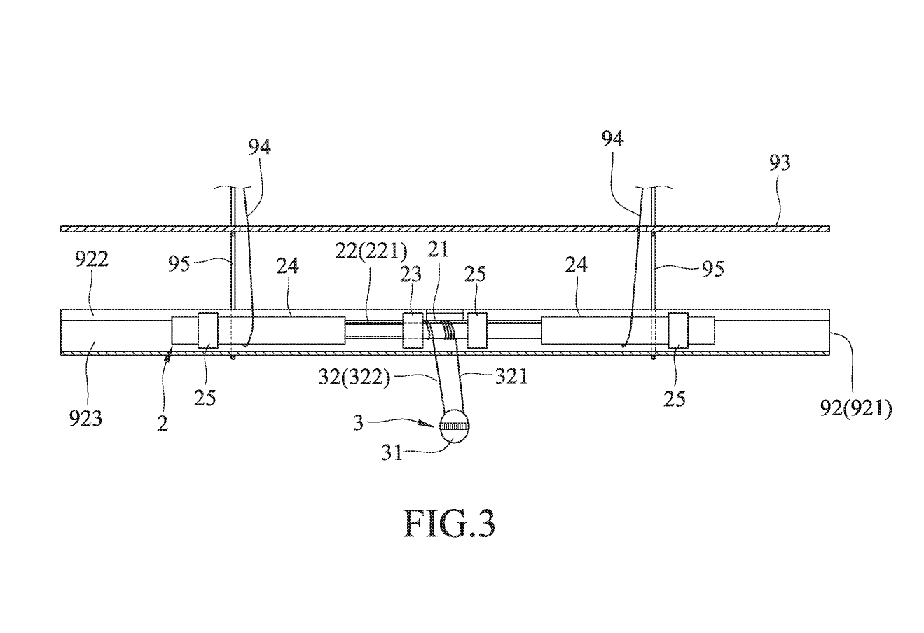

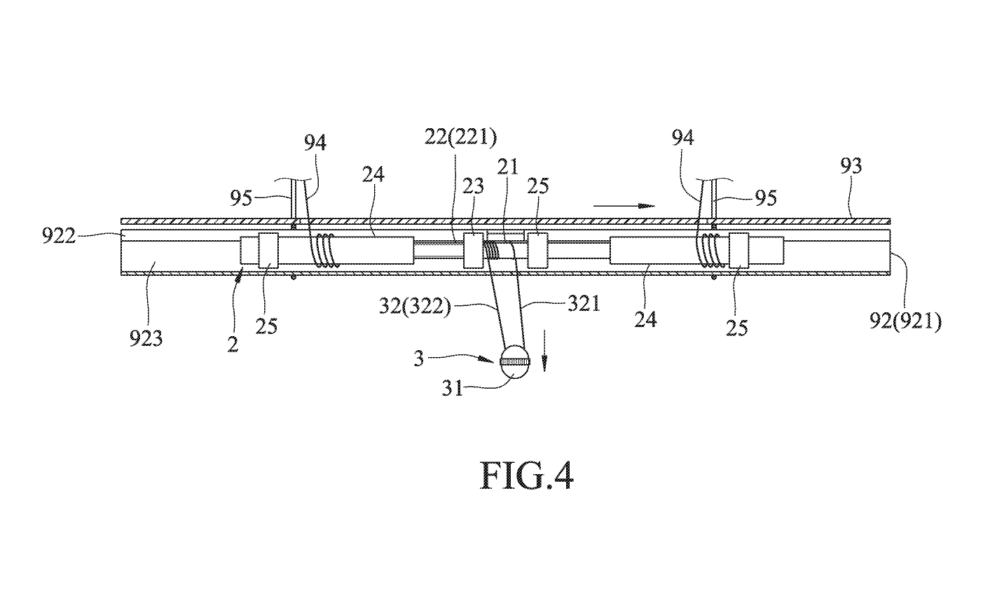

The rotary unit 2 of this embodiment includes a rotary shaft 21, a screw nut 23, two reel members 24, and a plurality of ring members 25. The rotary shaft 21 is mounted in the receiving space 923 of the lower rail 92, and is rotatable relative to the lower rail 92 about an extending axis thereof, such that rotation of the rotary shaft 21 drives movement of the lower rail 92 relative to the upper rail 91, i.e., to raise or to lower the lower rail 92 so as to drive movement of the slat members 93. As illustrated in FIGS. 3 and 4, the rotary shaft 21 has a threaded section 22 formed with an external thread 221. The screw nut 23 threadedly engages the threaded section 22 of the rotary shaft 21 via the external thread 221 and is fixedly connected to the lower rail 92, such that the rotary shaft 21 moves along the extending axis relative to the lower rail 92 upon the rotation of the rotary shaft 21 relative to the lower rail 92. The reel members 24 are mutually spaced apart, are co-movably sleeved on the rotary shaft 21, and are configured to permit, upon the rotation of the rotary shaft 21, the pull cords 94 to be wound respectively thereon. Each of the ring members 25 is spaced apart from the screw nut 23, surrounds a corresponding one of the reel members 24 and the rotary shaft 21, and is fixedly connected to the lower rail 92 so as to facilitate the rotation of the rotary shaft 21 and the reel members 24.

The driving unit 3 of this embodiment is linked to the rotary shaft 21 for driving the rotation thereof, so as to drive the movement of the lower rail 92 relative to the upper rail 91 for raising or lowering the slat members 93. In greater detail, the driving unit 3 includes a rope 32 connected to the rotary shaft 21, a holding member 31 provided on the rope 32, and a retaining member 36. The rope 32 has a middle section that extends through the holding member 31, and first and second end sections 321, 322 that extend away from each other from the middle section to respectively wind on the rotary shaft 21 in two opposite winding directions, such that each of the first and second end sections, upon being pulled, drives the rotation of the rotary shaft 21 in a respective one of two opposite first and second rotational directions about the extending axis. In other words, pulling the first end section 321 of the rope 32 may drive the rotary shaft 21 to rotate in the first rotational direction due to a corresponding one of the winding directions of the first end section 321, so as to raise the lower rail 92 and the slat members 93. Similarly, pulling the second end section 322 may drive the rotary shaft 21 to rotate in the second rotational direction due to the corresponding one of the winding directions of the second end section 322, so as to lower the lower rail 92 and the slat members 93.

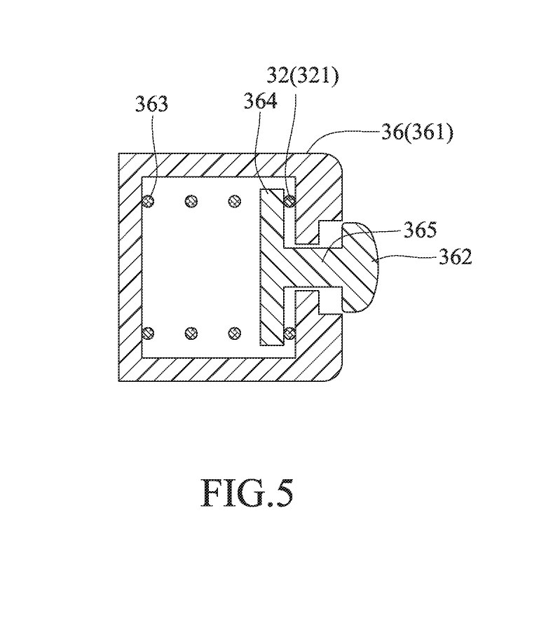

As illustrated in FIG. 5, the retaining member 36 is mounted to the lower rail 92 (not specifically illustrated) and includes a shell 361, a press member 362, and a biasing member 363. The press member 362 is mounted to the shell 361 and has a flange portion 364 received in the shell 361, and a button portion 365 extending from the flange portion 364 and outwardly of the shell 361. The first end section 321 of the rope 32 is wound on the button portion 365 and disposed between the flange portion 364 and the shell 361. The biasing member 363 is received in the shell 361 for resiliently biasing the flange portion 364 to push the first end section 321 of the rope 32 against an inner surface of the shell 361 so as to prevent movement of the first end section 321 of the rope 32 relative to the shell 361. The press member 362 is operable, upon being pressed, to move the flange portion 364 away from the inner surface of the shell 361 against the biasing action of the biasing member 363 so as to permit the movement of the rope 32 relative to the shell 361.

When desiring to raise the lower rail 92 and the slat members 93, e.g., to a state as illustrated in FIG. 3, a user may have one of his/her hands press the press portion 362 of the retaining member 36 to permit the movement of the first end section 321 of the rope 32 relative to the shell 361, and the other one of his/her hands pull the first end section 321 of the rope 32, so as to drive the rotary shaft 21 to rotate in the first rotational direction and thus to allow the pull cords 94 to be wound on the reel members 24 as illustrated in FIG. 3. In the meantime, the rotary shaft 21 moves along the extending axis relative to the lower rail 92 upon the rotation thereof relative to the lower rail 92 to allow the pull cords 94 to be evenly wound on the reel members 24. When the lower rail 92 and the slat members 93 are raised to predetermined positions, the user may release the press portion 362 of the retaining member 36 to retain the lower rail 92 and the slat members 93 at such positions.

Likewise, when lowering the lower rail 92 and the slat members 93, e.g., to a state as illustrated in FIG. 1, is desired, the user may have one of his/her hands to press the press portion 362 of the retaining member 36 to permit the movement of the second end section 322 of the rope 32, and the other one of his/her hands to pull the second end section 322 of the rope 32 by holding member 31, so as to unwind the pull cords 94 from the reel members 24. When the lower rail 92 and the slat members 93 are lowered to predetermined positions, the user may release the press portion 362 of the retaining member 36 to retain the lower rail 92 and the slat members 93 at such positions.

By controlling the rotary unit 2 via the driving unit 3, the driving device of the present disclosure is easy to operate and has no operation cord exposed from the window blind. The aforementioned drawback of the prior art can thus be prevented.

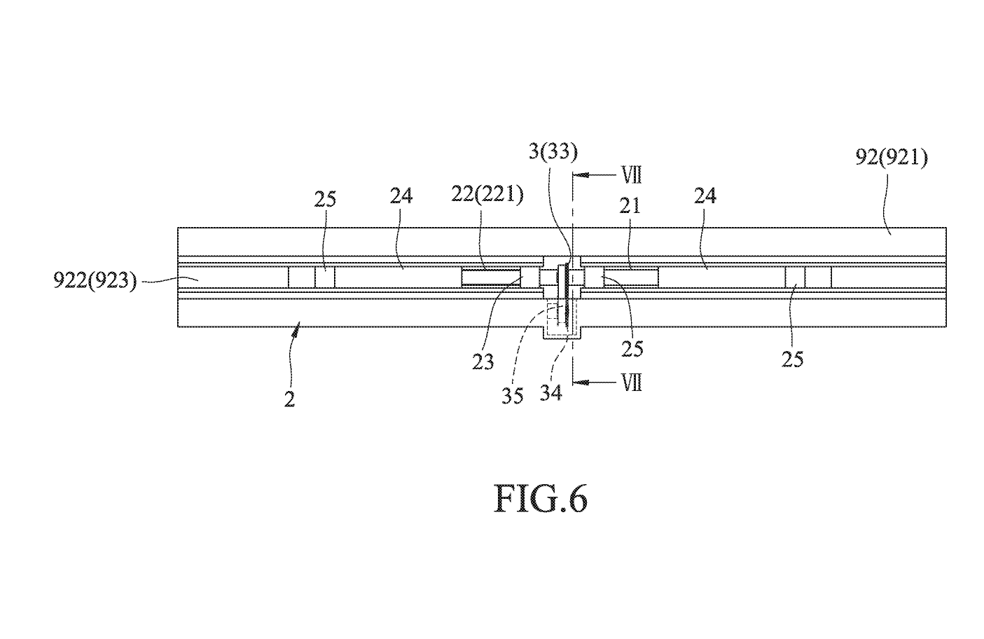

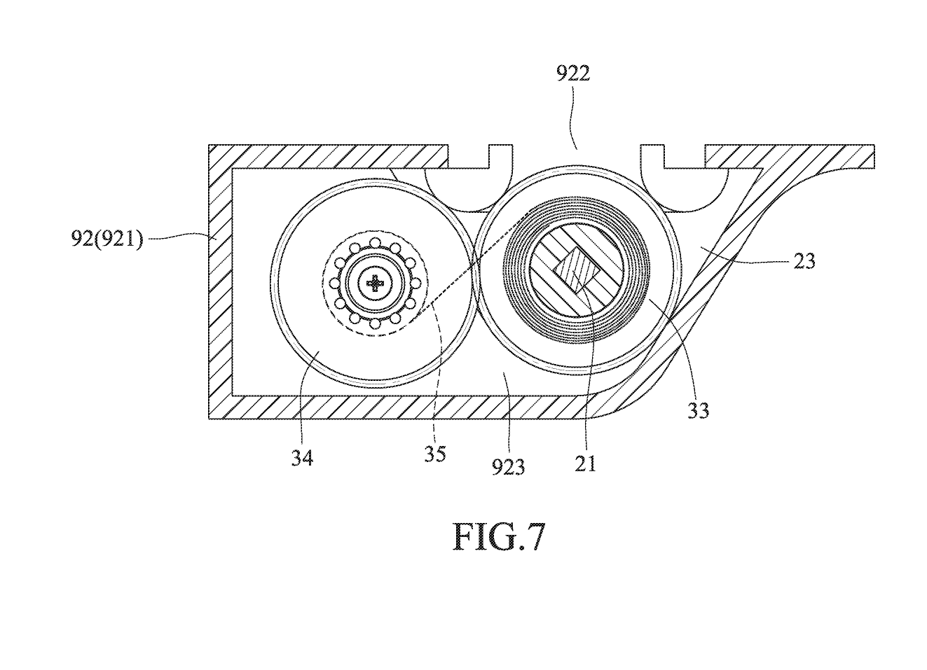

Referring to FIGS. 6 and 7, the second exemplary embodiment of the driving device according to the pre sent disclosure is similar to that of the first exemplary embodiment, with the differences set forth as follows. In the second exemplary embodiment, the driving unit 3 includes a first rotary seat 33 co-rotatably sleeved on the rotary shaft 21, a second rotary seat 34 linked to the first rotary seat 33 in such a manner that rotation of the first rotary seat 33 in a first rotational direction drives rotation of the second rotary seat 34 in a second rotational direction opposite to the first rotational direction, and a spiral spring 35 having opposite end sections to be respectively wound on the first and second rotary seats 33, 34. The spiral spring 35 tends to be entirely wound on one of the first and second rotary seats 33, 34 due to its resilient property so as to rotate the rotary shaft 21 to wind up the pull cords 94, which in turn moves the lower rail 92 upwardly relative to the upper rail 91 and raises the slat members 93. As shown in FIG. 7, the spiral spring 35 has an unwinding section passing through a space between the first and second rotary seats 33, 34. The driving device of the second exemplary embodiment has advantages similar to those of the first exemplary embodiment.

In sum, by way of controlling the rotary unit 2 via the driving unit 3, the driving device of the present disclosure is easy to operate and has no operation cord exposed from the window blind. The aforementioned drawback of the prior art can thus be prevented. It should be noted that the driving unit 3 can also be electrically powered by an electric motor or the like.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A driving device adapted for a window blind, the window blind including an upper rail, a lower rail defining a receiving space and having an opening, a plurality of slat members disposed between the upper and lower rails, and two pull cords each being connected to the upper rail and extending through the slat members and into the receiving space via the opening, said driving device comprising:
a rotary unit including
a rotary shaft that is mounted in the receiving space of the lower rail, that is rotatable relative to the lower rail about an extending axis thereof, and that is configured to permit the pull cords to be wound thereon, such that rotation of said rotary shaft drives movement of the lower rail relative to the upper rail, said rotary shaft having a threaded section, and
a screw nut that threadably engages said threaded section and that is fixedly connected to the lower rail, such that said rotary shaft moves along the extending axis relative to the lower rail upon the rotation thereof relative to the lower rail; and
a driving unit linked to said rotary shaft for driving the rotation of said rotary shaft.

1. driving device according to claim 1, wherein said rotary unit further includes two reel members that are mutually spaced apart and that are co-movably sleeved on said rotary shaft, said reel members being configured to permit, upon the rotation of said rotary shaft, the pull cords to be wound respectively thereon.

3. The driving device according to claim 2, wherein said rotary unit further includes a plurality of ring members each of which is spaced apart from said screw nut, surrounds a corresponding one of said reel members and said rotary shaft, and is fixedly connected to the lower rail.

4. The driving device according to claim 1, wherein said driving unit includes a rope connected to said rotary shaft, and a holding member provided on said rope, said rope having a middle section that extends through said holding member, and first and second end sections that extend away from each other from said middle section to respectively wind on said rotary shaft in two opposite winding directions, such that each of said first and second end sections, upon being pulled, drives the rotation of said rotary shaft in a respective one of two opposite first and second rotational directions about the extending axis.

5. The driving device according to claim 4, wherein:
said driving unit further includes a retaining member mounted to the lower rail, said retaining member including
a shell,
a press member movably mounted to said shell and having a flange portion received in said shell, and a button portion extending from said flange portion and outwardly of said shell, the first end section of said rope being wound on said button portion and disposed between said flange portion and shell, and
a biasing member received in said shell for resiliently biasing said flange portion to push said first end section of said rope against an inner surface of said shell so as to prevent movement of said first end section of said rope relative to said shell; and
said press member is operable, upon being pressed, to move said flange portion away from said inner surface of said shell against the biasing action of said biasing member so as to permit the movement of said first end section of said rope relative to said shell.

6. The driving device according to claim 1, wherein said driving unit includes:
a first rotary seat co-rotatably sleeved on said rotary shaft;
a second rotary seat linked to said first rotary seat in such a manner that rotation of said first rotary seat in a first rotational direction drives rotation of said second rotary seat in a second rotational direction opposite to said first rotational direction; and
a spiral spring having opposite end sections to be respectively wound on said first and second rotary seats, and tending to be entirely wound on one of said first and second rotary seats for rotating said rotary shaft to wind up the pull cords so as to move the lower rail upwardly relative to the upper rail.

7. The driving device according to claim 6, wherein said spiral spring further has an un-winding section passing through a space between said first and second rotary seats.
